(19) United States
(12) Patent Application Publication
(10) Pub. No.: US 2025/0097402 A1
(43) Pub. Date: Mar. 20, 2025

(54) INTERPOLATION OF REPROJECTED CONTENT

(71) Applicant: Apple Inc., Cupertino, CA (US)

(72) Inventors: Nathan P. ROWE, Erie, CO (US); Shruti SINGHAL, Campbell, CA (US)

(21) Appl. No.: 18/661,535

(22) Filed: May 10, 2024

Related U.S. Application Data
(60) Provisional application No. 63/538,788, filed on Sep. 15, 2023.

(51) Int. Cl. H04N 13/366; G06T 7/20; H04N 13/139

(52) U.S. Cl. CPC H04N 13/366; G06T 7/20; H04N 13/139

(57) ABSTRACT

Aspects of the subject technology provide for linear interpolation of reprojected blurred content. A system may reproject a first frame comprising a first blurred texture into a first reprojected frame using a first transformation associated with a viewing perspective of a user. The system also can reproject a second frame comprising a second blurred texture into a second reprojected frame using a second transformation associated with the viewing perspective of the user. The system can determine a motion approximation between the first reprojected frame and the second reprojected frame. The system also can render an intermediate frame based at least in part on the motion approximation, the intermediate frame being rendered between the first reprojected frame and the second reprojected frame.

### CROSS-REFERENCE TO RELATED APPLICATION(S)

This application claims the benefit of U.S. Provisional Application Ser. No. 63/538,788, entitled “INTERPOLATION OF REPROJECTED CONTENT,” and filed on Sep. 15, 2023, the disclosure of which is expressly incorporated by reference herein in its entirety.

### TECHNICAL FIELD

The present description relates generally to reprojected content including, for example, interpolation of reprojected content.

### BACKGROUND

Augmented reality technology aims to bridge a gap between virtual environments and a physical environment by providing a view of the physical environment that is augmented with electronic information. As a result, the electronic information appears to be part of the physical environment as perceived by a user.

### BRIEF DESCRIPTION OF THE DRAWINGS

Certain features of the subject technology are set forth in the appended claims. However, for purpose of explanation, several implementations of the subject technology are set forth in the following figures.

FIG. 1 illustrates an example system architecture including various electronic devices that may implement the subject system in accordance with one or more implementations of the subject technology.

FIG. 2 illustrates an example electronic device providing linear interpolation of reprojected blurred content in accordance with one or more implementations of the subject technology.

FIG. 3 conceptually illustrates an example of blur texture computation in a sequence of frames in accordance with one or more implementations of the subject technology.

FIG. 4 illustrates a flow diagram of an example process for providing linear interpolation of reprojected blurred content in accordance with one or more implementations of the subject technology.

FIG. 5 illustrates graph diagrams providing different examples of linear interpolation of reprojected blurred content in accordance with one or more implementations of the subject technology.

FIG. 6 illustrates graph diagrams providing different examples of extrapolation of reprojected blurred content in accordance with one or more implementations of the subject technology.

FIG. 7 illustrates an example computing device with which aspects of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The process of blurring content is a resource-intensive operation. In the context of Head-Mounted Displays (HMDs), reprojection techniques can be employed to decrease the frequency at which updated content is rendered. However, excessively reducing the framerate can lead to judder, adversely affecting the user experience. To address this challenge, when dealing with blurred content specifically, a further reduction in framerate can be achieved through the utilization of linear interpolation. This technique can leverage the inherent mathematical properties of Gaussians (or other blur algorithms) to closely approximate movement.

Implementations of the subject technology described herein provide for enhancing image interpolation by applying linear interpolation to reprojected blurred images. Unlike previous approaches, which did not employ linear interpolation between reprojected blurred images, the subject technology utilizes linear interpolation on the reprojected blurred images to achieve substantial savings in computational performance while maintaining image quality. Because this approach involves reprojection of blurred content, any artifacts introduced by the linear interpolation performed between reprojected frames would be effectively masked and less apparent to users. Additionally, the subject technology may utilize different kernels, such as Gaussian distributions, to optimize motion approximation. The subject technology may utilize, for example, the L infinity norm as a metric for measuring the proximity of interpolated peaks to translated peaks. The subject technology also addresses the issue of widening blur lines during interpolation by saving progressively blurrier versions of frames to maintain a constant standard deviation. In one or more implementations, implementing multiple blur kernels may incur computational costs; however, it can be beneficial in scenarios where generating and blurring images incurs significant computational costs. One or more other implementations of the subject technology described herein provide for the integration of linear interpolation with temporal anti-aliasing (TAA) to further enhance image quality by mitigating overshooting and ensuring smoother temporal transitions.

In one or more implementations, the subject system may reproject a first frame with a first blurred texture using a first transformation associated with a viewing perspective of a user. The system also can reproject a second frame with a second blurred texture using a second transformation associated with the viewing perspective of the user. The system can then determine a motion approximation between the first reprojected frame and the second reprojected frame. The system also can render an intermediate frame based at least in part on the motion approximation, in which the intermediate frame can be rendered between the first reprojected frame and the second reprojected frame. The previously outlined steps can contribute to an enhanced functionality of a computer system by optimizing graphics processing, resource allocation, real-time rendering, latency reduction, and the advancement of computational techniques. These improvements collectively lead to a more efficient, responsive, and versatile computing environment that benefits both users and a wide range of applications.

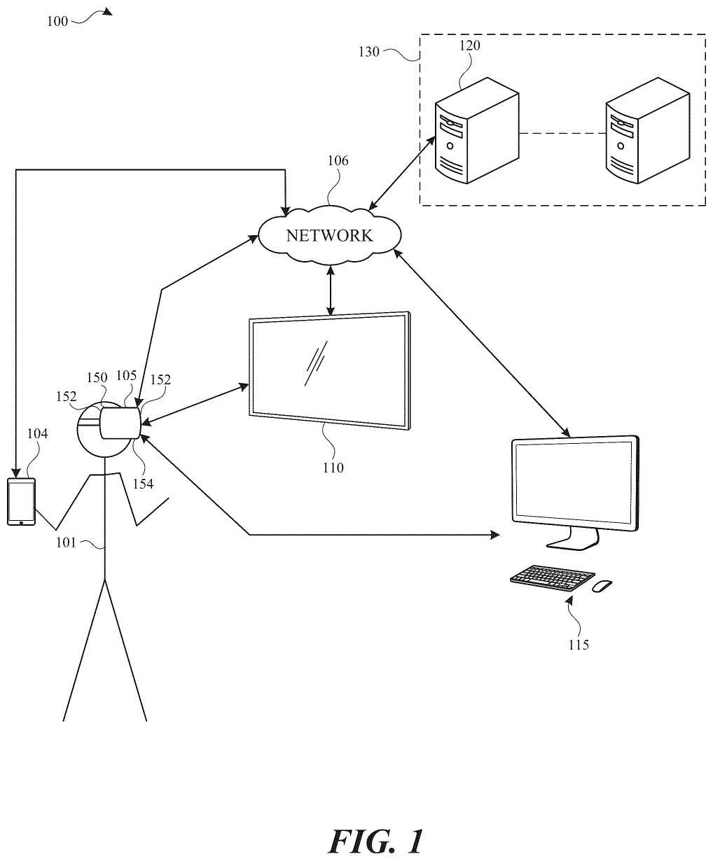

These and other embodiments are discussed below with reference to FIGS. 1-5. However, those skilled in the art will readily appreciate that the detailed description given herein with respect to these Figures is for explanatory purposes only and should not be construed as limiting.

FIG. 1 illustrates an example system architecture 100 including various electronic devices that may implement the subject system in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The system architecture 100 includes an electronic device 105, a handheld electronic device 104, an electronic device 110, an electronic device 115, and a server 120. For explanatory purposes, the system architecture 100 is illustrated in FIG. 1 as including the electronic device 105, the handheld electronic device 104, the electronic device 110, the electronic device 115, and the server 120; however, the system architecture 100 may include any number of electronic devices, and any number of servers or a data center including multiple servers.

The electronic device 105 is illustrated in FIG. 1 s a head-mounted portable system (e.g., worn by a user 101); however, the electronic device 105 may also be implemented, for example, as a tablet device, a handheld and/or mobile device. The electronic device 105 includes a display system capable of presenting a visualization of a computer-generated reality environment to the user. The electronic device 105 may be powered with a battery and/or another power supply. In an example, the display system of the electronic device 105 provides a stereoscopic presentation of the computer-generated reality environment, enabling a three-dimensional visual display of a rendering of a particular scene, to the user. In one or more implementations, instead of, or in addition to, utilizing the electronic device 105 to access a computer-generated reality environment, the user may use a handheld electronic device 104, such as a mobile device, tablet, watch, and the like.

The electronic device 105 may include one or more cameras such as camera(s) 150 (e.g., visible light cameras, infrared cameras, etc.). Further, the electronic device 105 may include various sensors 152 including, but not limited to, cameras, image sensors, touch sensors, microphones, inertial measurement units (IMU), heart rate sensors, temperature sensors, depth sensors (e.g., Lidar sensors, radar sensors, sonar sensors, time-of-flight sensors, etc.), GPS sensors, Wi-Fi sensors, near-field communications sensors, radio frequency sensors, etc. Moreover, the electronic device 105 may include hardware elements that can receive user input such as hardware buttons or switches. User input detected by such sensors and/or hardware elements correspond to, for example, various input modalities for performing one or more actions, such as initiating video capture of physical and/or virtual content. For example, such input modalities may include, but are not limited to, facial tracking, eye tracking (e.g., gaze direction), hand tracking, gesture tracking, biometric readings (e.g., heart rate, pulse, pupil dilation, breath, temperature, electroencephalogram, olfactory), recognizing speech or audio (e.g., particular hotwords), and activating buttons or switches, etc.

In one or more implementations, the electronic device 105 may be communicatively coupled to a base device the electronic device 115. Such a base device may, in general, include more computing resources and/or available power in comparison with the electronic device 105. In an example, the electronic device 105 may operate in various modes. For instance, the electronic device 105 can operate in a standalone mode independent of any base device. When the electronic device 105 operates in the standalone mode, the number of input modalities may be constrained by power and/or processing limitations of the electronic device 105 such as available battery power of the device. In response to power limitations, the electronic device 105 may deactivate certain sensors within the device itself to preserve battery power and/or to free processing resources.

The electronic device 105 may also operate in a wireless tethered mode (e.g., connected via a wireless connection with a base device), working in conjunction with a given base device. The electronic device 105 may also work in a connected mode where the electronic device 105 is physically connected to a base device (e.g., via a cable or some other physical connector) and may utilize power resources provided by the base device (e.g., where the base device is charging the electronic device 105 while physically connected).

In one or more implementations, when the electronic device 105 operates in the wireless tethered mode or the connected mode, a least a portion of processing user inputs and/or rendering the computer-generated reality environment may be offloaded to the base device thereby reducing processing burdens on the electronic device 105. For instance, in an implementation, the electronic device 105 works in conjunction with the electronic device 115 to generate a computer-generated reality environment including physical and/or virtual objects that enables different forms of interaction (e.g., visual, auditory, and/or physical or tactile interaction) between the user and the generated computer-generated reality environment in a real-time manner. In an example, the electronic device 105 provides a rendering of a scene corresponding to the computer-generated reality environment that can be perceived by the user and interacted with in a real-time manner. Additionally, as part of presenting the rendered scene, the electronic device 105 may provide sound, and/or haptic or tactile feedback to the user. The content of a given rendered scene may be dependent on available processing capability, network availability and capacity, available battery power, and current system workload.

The network 106 may communicatively (directly or indirectly) couple, for example, the electronic device 104, the electronic device 105, the electronic device 110, and/or the electronic device 115 with each other device and/or the server 120. In one or more implementations, the network 106 may be an interconnected network of devices that may include, or may be communicatively coupled to, the Internet.

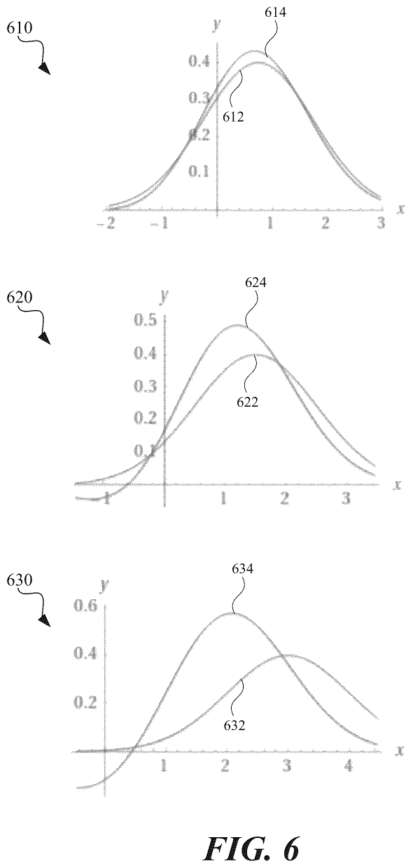

In FIG. 1, by way of example, the electronic device 110 is depicted as a television. The electronic device 110 may include a touchscreen and may be, for example, a television that includes a touchscreen, a smartphone that includes a touchscreen, a portable computing device such as a laptop computer that includes a touchscreen, a companion device that includes a touchscreen (e.g., a digital camera, headphones), a tablet device that includes a touchscreen, a wearable device that includes a touchscreen such as a watch, a band, and the like, any other appropriate device that includes, for example, a touchscreen, or any electronic device with a touchpad. In one or more implementations, the electronic device 110 may not include a touchscreen but may support touchscreen-like gestures, such as in a computer-generated reality environment. In one or more implementations, the electronic device 110 may include a touchpad. In one or more implementations, the electronic device 110, the handheld electronic device 104, and/or the electronic device 105 may be, and/or may include all or part of, the electronic device discussed below with respect to the electronic system discussed below with respect to FIG. 6. In one or more implementations, the electronic device 110 may be another device such as an Internet Protocol (IP) camera, a tablet, or a companion device such as an electronic stylus, etc.

The electronic device 115 may be, for example, desktop computer, a portable computing device such as a laptop computer, a smartphone, a companion device (e.g., a digital camera, headphones), a tablet device, a wearable device such as a watch, a band, and the like. In FIG. 1, by way of example, the electronic device 115 is depicted as a desktop computer. The electronic device 115 may be, and/or may include all or part of, the electronic system discussed below with respect to FIG. 8.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering and generating content such as graphics, images, video, audio and multi-media files for computer-generated reality environments. In an implementation, the server 120 may function as a cloud storage server that stores any of the aforementioned computer-generated reality content generated by the above-discussed devices and/or the server 120.

Embodiments of the subject technology in the present disclosure provide for enhancing image reprojection by employing a combination of reprojected blurred images and linear interpolation. Initially, the electronic device 105 renders a primary frame containing a blurred texture. For example, blurring some content may be helpful to help deemphasize that content relative to other content, or provide other visual cues to the user. In a spatial computing environment, the content may change depending on a user's viewing perspective (e.g., as the user turns his or her head). Because the blurring algorithm may require a substantial amount of processing, it may be desirable to avoid frequent recalculation of the blurring algorithm. To preserve content changes due to viewing perspective while avoiding such recalculation, the primary frame containing the blurred texture rendered for an initial user perspective can be reprojected to the user's current perspective. A similar procedure is employed for a secondary frame, also containing a blurred texture. The electronic device 105 reprojects this frame as well, utilizing a distinct transformation tailored to the user's viewing perspective. As used herein, the term “blurred texture” can refer to an image or graphical representation that has undergone a blurring process, resulting in a softened and less defined appearance. This effect is achieved by averaging or blending neighboring pixels, causing details to become less sharp and distinct, often creating a smoother and more gradual transition between different elements within the image.

Moreover, the electronic device 105 can compute an approximation of motion between the reprojected frames derived earlier. This approximation quantifies the extent of movement or change occurring between the two frames. Additionally, the electronic device 105 undertakes the task of rendering an intermediate frame, leveraging the calculated motion approximation as a guiding factor in the rendering process. Notably, this intermediate frame can be rendered between the previously mentioned first and second reprojected frames. The subject technology involves a blend of reprojected blurred images and linear interpolation to enhance image reprojection. The electronic device 105 executes these steps, ultimately leading to improved visual quality and more accurate representations of images, particularly in scenarios involving dynamic perspectives and motion dynamics, while achieving substantial savings in computational costs.

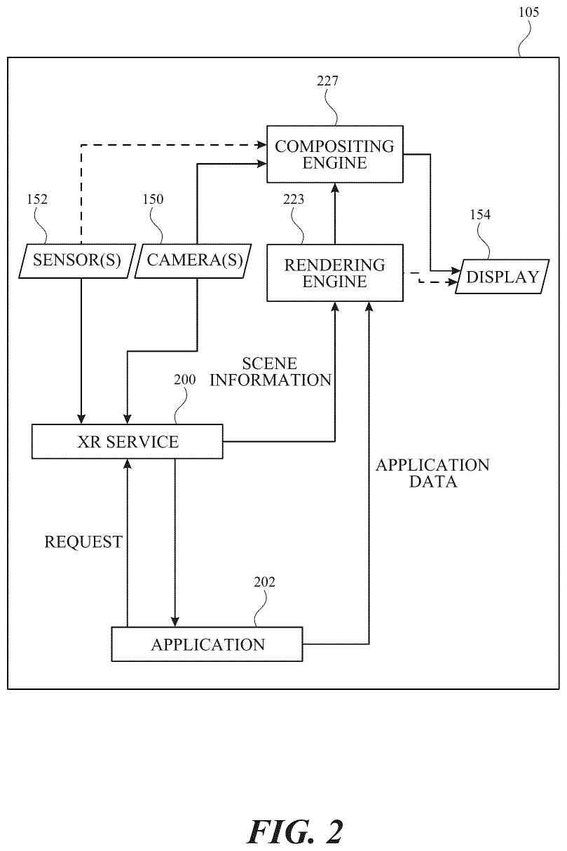

FIG. 2 illustrates how a system process of the electronic device 105 may provide linear interpolation of reprojected blurred content. For example, FIG. 2 illustrates an example architecture that may be implemented by the electronic device 105 in accordance with one or more implementations of the subject technology. For explanatory purposes, portions of the architecture of FIG. 2 are described as being implemented by the electronic device 105 of FIG. 1, such as by a processor and/or memory of the electronic device; however, appropriate portions of the architecture may be implemented by any other electronic device, including the electronic device 110, electronic device 115, and/or server 120. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

Various portions of the architecture of FIG. 2 can be implemented in software or hardware, including by one or more processors and a memory device containing instructions, which when executed by the processor cause the processor to perform the operations described herein. For example, in FIG. 2, the trapezoidal boxes may indicate that the sensors 152, the camera(s) 150 and the display 154 may be hardware components, and the rectangular boxes may indicate that the XR service 200, the application 202, the rendering engine 223, and the compositing engine 227 may be implemented in software, including by one or more processors and a memory device containing instructions, which when executed by the processor cause the processor to perform the operations described herein.

In the example of FIG. 2, an application such as application 202 provides application data to a rendering engine 223 for rendering of the application data, such as for rendering of a UI of the application 202. Application 202 may be a gaming application, a media player application, a content-editor application, a training application, a simulator application, a social media application, or generally any application that provides a UI or other content for display at a location that depends on the physical environment, such as by anchoring the UI or other content to an anchor in the physical environment. The application data may include application-generated content (e.g., windows, buttons, tools, characters, images, videos, etc.) and/or user-generated content (e.g., text, images, etc.), and information for rendering the content in the UI. In one or more implementations, rendering engine 223 renders the UI of the application 202 for display by a display such as display 154 of the electronic device 105. In one or more implementations, the XR service 200 may assign a portion of a physical environment of the electronic device to the application 202.

As shown in FIG. 2, additional information may be provided for display of the UI of the application 202, such as in a two-dimensional or three-dimensional (e.g., XR) scene. In the example of FIG. 2, sensors 152 may provide physical environment information (e.g., depth information from one or more depth sensors, motion information from one or more motion sensors), and/or user information to an XR service 200. Camera(s) 150 may also provide images of a physical environment and/or one or more portions of the user (e.g., the user's eyes, hands, face, etc.) to XR service 200. XR service 200 may generate scene information, such as three-dimensional map, of some or all of the physical environment of electronic device 105 using the environment information (e.g., the depth information and/or the images) from sensors 152 and camera(s) 150. The XR service 200 may also determine a gaze location based on images and/or other sensor data representing the position and/or orientation of the user's eye(s). The XR service 200 may also identify a gesture (e.g., a hand gesture) performed by a user of the electronic device 105, based on images and/or other sensor data representing the position and/or orientation of the user's hand(s) and/or arm(s).

As illustrated in FIG. 2, in one or more implementations, the application 202 may provide a request to the XR service 200. For example, the request may be a request for scene information (e.g., information describing the content of the physical environment), and/or a request for user information such as a request for a gaze location and/or user gesture information. In one example, the request may be an anchor request for a physical anchor (e.g., a horizontal surface, a vertical surface, a floor, a table, a wall, etc.).

Application 202 may include code that, when executed by one or more processors of electronic device 105, generates application data, for display of the UI of the application 202 on, near, attached to, or otherwise associated with an anchor location corresponding to the anchor identified by the identifier provided from XR service 200. Application 202 may include code that, when executed by one or more processors of electronic device 105, modifies and/or updates the application data based on user information (e.g., a gaze location and/or a gesture input) provided by the XR service 200.

Once the application data has been generated, the application data can be provided to the XR service 200 and/or the rendering engine 223, as illustrated in FIG. 2. As shown, scene information can also be provided to rendering engine 223. The scene information provided from the XR service 200 to the rendering engine 223 can include or be based on, as examples, environment information such as a depth map of the physical environment, and/or object information for detected objects in the physical environment. Rendering engine 223 can then render the application data from application 202 for display by display 154 of electronic device 105 to appear at a desired location in a physical environment. Display 154 may be, for example, an opaque display, and camera(s) 150 may be configured to provide a pass-through video feed to the opaque display. The UI of the application 202 may be rendered for display at a location on the display corresponding to the displayed location of a physical anchor object in the pass-through video. Display 154 may be, as another example, a transparent or translucent display. The UI of the application 202 may be rendered for display at a location on the display corresponding to a direct view, through the transparent or translucent display, of the physical environment.

As shown, in one or more implementations, electronic device 105 can also include a compositing engine 227 that composites video images of the physical environment, based on images from camera(s) 150, for display together with the UI of the application 202 from rendering engine 223. For example, compositing engine 227 may be provided in an electronic device 105 that includes an opaque display, to provide pass-through video to the display. In an electronic device 105 that is implemented with a transparent or translucent display that allows the user to directly view the physical environment, compositing engine 227 may be omitted or unused in some circumstances or may be incorporated in rendering engine 223. Although the example of FIG. 2 illustrates a rendering engine 223 that is separate from XR service 200, it should be appreciated that XR service 200 and rendering engine 223 may form a common service and/or that rendering operations for rendering content for display can be performed by the XR service 200. Although the example of FIG. 2 illustrates a rendering engine 223 that is separate from application 202, it should be appreciated that, in some implementations, application 202 may render content for display by display 154 without using a separate rendering engine. Although a single instance of the application 202 is depicted in FIG. 2, it is appreciated that multiple applications may be running concurrently on the electronic device 105, generating application data for rendering of respective UIs for display by display 154. In one or more implementations, compositing engine 227 may composite application data for multiple UIs of multiple applications for concurrent display.

When the electronic device 105 is rendering VR content, the computation of new frames by the rendering engine 223 at a high refresh rate, such as 90 hertz, may become prohibitively expensive. Consequently, the rendering engine 223 may employ a lower frame rate, accompanied by reprojecting a previous frame using a camera transform that corresponds to a user's viewing perspective. This technique may involve various iterations of reprojection to approximate an intermediate frame without the need for full computation. However, when dealing with blurred textures, a cost-effective and highly accurate approximation can be achieved by performing linear interpolation (e.g., lerping) the blurry images, as these images inherently capture the desired motion. This lerping approach can offer the advantage of attaining the quality of an expensive reprojection, which accounts for ongoing translations and other factors, but at a significantly reduced cost when applied to reprojecting blurry textures. In the subject technology, where blurry textures are prevalent and computed at reduced frame rates, this lerping can yield substantial savings in computational performance while maintaining quality.

The rendering engine 223 can render VR content by employing blurred images for reprojection and utilizing lerping for interpolation. In one or more implementations, lerping is combined with the reprojection of blurred images, rather than simply reprojecting the most recent image to the user's current perspective. Because lerping can introduce motion artifacts, the combination of lerping and reprojection may be performed selectively, based on properties of the content. For example, in the case of already blurry images, both lerping and reprojection can be effectively applied because the images are already blurred and therefore the human eye is unlikely to notice the additional degradation. Due to the shape of blur kernels, this combined approach efficiently interpolates motion and effectively masks artifacts through the pre-existing blurring. As a result, the rendering engine 223 achieves improved results by selectively incorporating lerping into the reprojection process, in particular for content such as blurred images for which the blurring effect of interpolation is masked by the properties of the content.

The rendering engine 223 can achieve a significant improvement in compute reduction, for example reducing the blur rendering workload over a sequence of four frames from about 4% to about 2%, which corresponds to a halving of the computation tasks. This achievement may be made possible by skipping three out of the four frames of the sequence during the computation process. The primary savings can be attributed to the computation of the blur texture, a computationally expensive task that previously utilized approximately one-third of a millisecond on the GPU. However, with the approach of the subject technology, the computation can now occur every fourth frame. The reduction to half rate is achieved through frame reprojection, which incurs minimal cost in comparison to the computation of the texture from scratch. Additionally, the further decrease from ½ to ¼ compute rate is facilitated by the utilization of lerping. The rendering engine 223 optimizes this process to achieve significant computational savings and enhance overall performance in rendering blurred images.

In one or more implementations, the rendering engine 223 utilizes the Euler method to execute the rendering process in the following manner. In one or more implementations, the rendering process involves generating and blending blurred frames over a sequence of X frames, where X represents a variable number. However, for the sake of this example, the value of X is given as four. This means that the rendering process takes place over a sequence of four frames. Initially, during the rendering of frame zero, the rendering engine 223, for example, generates a blurred version of the content of the image. In some aspects, frame zero refers to the initial frame in a sequence of frames being rendered. While rendering a blur frame one, the rendering engine 223 already has access to the previously blurred frame zero. In some aspects, frame one refers to the subsequent frame in the sequence, following frame zero. In this case, it is rendered as a blurred frame. Instead of immediately displaying blur frame one as the most recent frame, the rendering engine 223 combines blur frame zero and blur frame one. In this case, the blending of frames involves gradually combining the information from frame zero and frame one to create a smooth transition between the two blurred frames. In one or more implementations, the rendering engine 223 considers other old frames such as frame two or frame three, which are frames that follow frame zero and frame one in the sequence. This progressive blending allows the rendering engine 223 to gradually display a larger portion of the transition from frame zero to frame one in subsequent frames, creating a forward loop effect.

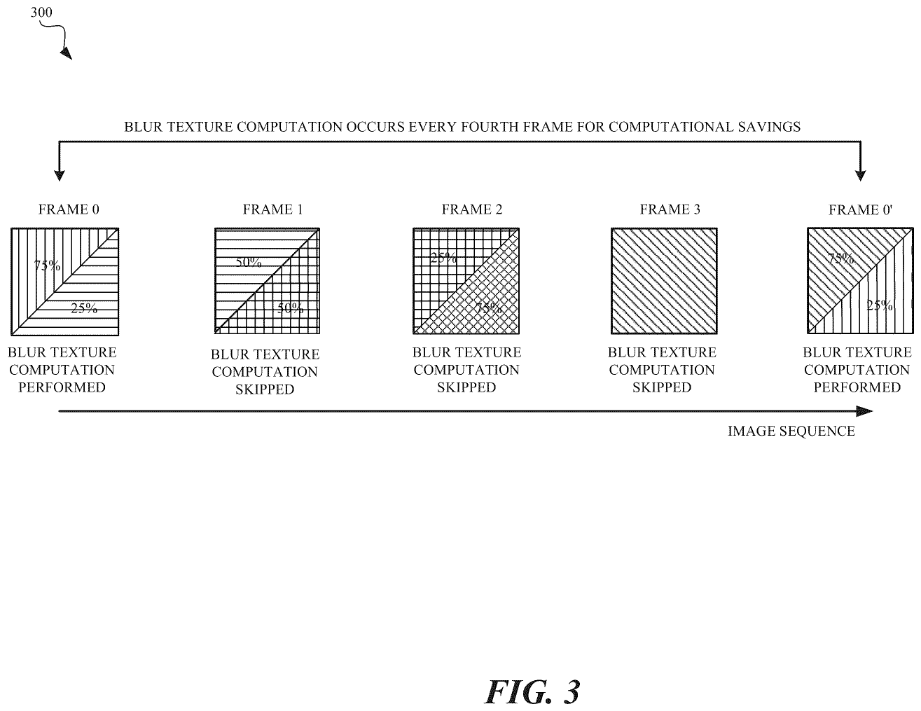

FIG. 3 conceptually illustrates an example 300 of blur texture computation in a sequence of frames in accordance with one or more implementations of the subject technology. In one or more implementations, the rendering engine 223 performs rendering at a quarter of the frame rate. During the rendering of frame zero (denoted as “Frame 0”), the displayed blur texture includes 75% of the previous frame (with higher latency) and 25% of the new frame, resulting in the intended blur effect. This incorporation of a significant portion of the previous frame facilitates smooth motion in the blur frames and reduces perceived judder, despite introducing some additional latency. Upon reaching frame one (denoted as “Frame 1”), the rendering engine 223 displays a 50/50 blend of the new and previous frames. At frame two (denoted as “Frame 2”), 75% of the latest new frame (now two frames old) is combined with 25% of the older frame (six frames old). The rendering engine 223 applies reprojection to align these frames with the current frame. When frame three is reached (denoted as “Frame 3”), the rendering engine 223 displays the new frame without blending in any of the previous frames. Finally, at a new frame zero (denoted as “Frame 0′”), the rendering engine 223 computes a new blur texture, and it is blended with 25% of the new frame zero along with 75% of the previous texture (e.g., frame three), which is now considered the old texture.

As used herein, the term “Gaussian kernel” refers to a mathematical function or a smoothing filter that is applied to modify or process an image. The Gaussian distribution, a probability distribution that is characterized by its bell-shaped curve, may be used with the Gaussian kernel due to its desirable isotropic properties, such as its ability to smooth out noise and preserve edges in an image. The Gaussian kernel may be a discrete approximation of the continuous Gaussian distribution. The Gaussian kernel may be a one-dimensional or multi-dimensional array of values that represents the weights assigned to neighboring data points during convolution. Data points closer to the center of the Gaussian kernel have higher weights and contribute more to the resulting value, and those farther away have lower weights and contribute less to the resulting value, following the Gaussian distribution's bell-shaped curve.

To apply the Gaussian kernel, a convolution operation is performed between the kernel and the input data (e.g., the image). The Gaussian kernel may be centered at each data point, and the values within the Gaussian kernel are multiplied by the corresponding data values in the image. The results are then summed to produce the output value at that data point (or pixel). Since the Gaussian kernel assigns higher weights to nearby data points (according to the Gaussian distribution), the convolution operation effectively blurs or smooths the data by averaging nearby values.

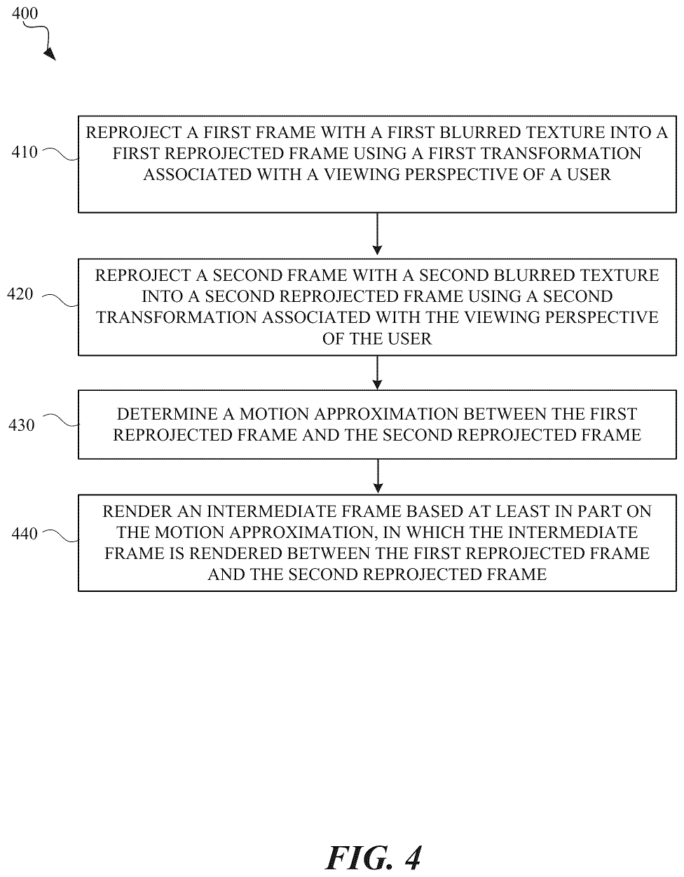

Referring back to FIG. 2, for example, the rendering engine 223 convolves the Gaussian kernel with the image, which involves passing the distribution over each pixel and combining their values to produce a modified pixel value. The Gaussian kernel's use of the Gaussian distribution facilitates that the convolution operation smooths out rapid changes or noise in the data. A resulting convolution operation with the Gaussian kernel, such as a convolution filter which will be described in more detail below in FIG. 4, blurs the image and reduces high-frequency components due to the Gaussian weighting while low-frequency components (such as underlying patterns) are preserved. In one or more implementations, the size and standard deviation of the Gaussian kernel determine the extent and strength of the blurring effect. For example, a larger standard deviation results in a wider kernel and more pronounced blurring, while a smaller standard deviation yields less blurring.

In a Gaussian kernel, sigma (c) refers to the standard deviation of the Gaussian distribution. The standard deviation determines the width or spread of the Gaussian distribution curve. A larger sigma value can result in a wider Gaussian kernel, which leads to a more significant blurring effect when convolved with an image. Conversely, a smaller sigma value produces a narrower Gaussian kernel and a less pronounced blurring effect. The sigma parameter facilitates controlling the amount of smoothing or blurring applied to the image. The sigma parameter may directly influence the shape and characteristics of the Gaussian kernel, impacting the trade-off between preserving image details and reducing noise or high-frequency components. Adjusting the sigma value allows fine-tuning the blurring effect to achieve the desired balance between image smoothness and detail preservation during image processing operations.

The rendering engine 223 utilizes a selected sigma value to control the extent of blurriness present in the images. The rendering engine 223 can be configured to select a sigma value to achieve a specific balance between blurriness and clarity. If the images were to become excessively blurry, the details behind the blurred texture would become indistinguishable. In one or more implementations, the rendering engine 223 can apply the lerping operation by adjusting the sigma value to eliminate enough detail to maintain the legibility of text on the blurred texture while still allowing for the visibility of background details. Therefore, the sigma value can be adjusted to an optimal value to strike this balance effectively.

In one or more implementations, the rendering engine 223 aims to avoid increasing the sigma value. As the sigma value increases, the blurring effect becomes more pronounced. If the sigma value is set too high, important details within the image, such as text, intricate patterns, or fine textures, can become excessively blurred and difficult to discern. This loss of detail may hinder the legibility of text or compromise the visual quality of the image. However, in scenarios involving significant motion, it may be feasible to consider increasing the sigma as the additional blurriness may not be readily noticeable due to the inherent difficulty in perceiving details amidst high motion. In one or more implementations, the rendering engine 223 can select an optimal sigma value in a range of 0 to 1 to maintain the desired level of blur for smoothing and noise reduction without compromising overall image legibility and quality.

Significant changes to the sigma value, executed by the rendering engine 223, may cause image features to become largely obscured and noticeable to users, and the goal of the subject technology is to instead maintain an imperceptible reprojection process. In cases where high levels of motion necessitate increasing the sigma, users may perceive several distinct effects in the resulting image (e.g., loss of detail, indistinct edges and boundaries, reduced text legibility, smoothed appearance, loss of fine textures, halo or glow effects, loss of clarity and fidelity), impacting the overall visual quality and interpretation of the resulting image. Hence, there may be considerations associated with sigma adjustments primarily driven by considerations of user experience, which the rendering engine 223 takes into account to facilitate a seamless and natural visual experience for users. If the legibility of text during the blur is disregarded, the rendering engine 223 could continue increasing the blur to minimize judder. Nonetheless, since the rendering engine 223 can be configured to maintain a minimum level of clarity behind the blurring, in one or more implementations, there may be a restriction on how much the sigma can be adjusted. The rendering engine 223 may consider these constraints to determine an optimal balance between blur reduction and maintaining visual clarity for the best user experience.

In one or more implementations, the rendering engine 223 introduces latency between two previous frames in a sequence of frames being rendered to facilitate gradual interpolation between reproductions of the two previous frames. The introduced latency may help to avoid blurring artifacts from appearing every other frame. In the context of already blurred images, such as those handled by the rendering engine 223 such latency may be omitted as interpolating between them does not result in further blur artifacts.

The advantage of this approach is the ability of the rendering engine 223 to significantly reduce the frequency at which blurs need to be calculated as part of the overall effort to conserve rendering resources, lowering the frame rate from the original 45 FPS to as low as 20 or 22.5 FPS, corresponding to a quarter rate or potentially even lower. While taking a conservative approach, the rendering engine 223 can reduce the computation usage of the blurring process from approximately 4% to 2% of resources of the electronic device 105, representing a significant improvement in computational costs.

To determine when the rendering engine 223 should employ a particular linear progression or similar technique, the XR service 200 or the application 202 may embed a tag or flag within the frame itself. In one or more implementations, this information is derived from a pre-pass phase that takes place during each frame, dedicated to computing the blur texture to be utilized for that specific frame. This computation is triggered by a predetermined signal indicating the need to generate the blur texture. In one or more other implementations, the rendering engine 223 may employ a ping pong buffer that stores the two most recent frames, enabling the rendering engine 223 to track the number of frames being reused and the current position within the forward loop. Consequently, in the subsequent frame, the rendering engine 223 increments the counter, advancing the loop by a factor of 0.5, for example, as prescribed.

When the frame rate is lowered from a rate of 45 Hz to 30 Hz or further to 22.5 Hz, visual artifacts may become noticeable in the rendered images. In one or more implementations, to mitigate the impact of these artifacts, the rendering engine 223 incorporates an alert mechanism. The purpose of the alert mechanism may be to detect the presence of these artifacts or other undesirable visual effects that may occur when the frame rate is decreased. Upon detection, the alert mechanism triggers a responsive action to address the detected issues and enhance the quality of the rendered output. In the case of reprojection without incorporating the alert mechanism, the rendering engine 223 can compute blurs at a rate of 45 Hz without any visible judder. However, when the frame rate is reduced to 30 Hz, artifacts become noticeable, and at 22.5 Hz, these artifacts become more pronounced. To address this issue, the rendering engine 223 can leverage the presence of TAA within the blurs. TAA is a technique that helps reduce aliasing and flickering artifacts in dynamic scenes or when frame rates are lowered, for example by accumulating pixel values between frames over time, adjusted by user perspective of those frames. By incorporating TAA into the blurring calculations, the rendering engine 223 aims to enhance the overall visual quality and ensure a smoother and more visually appealing output, even at lower frame rates.

When the rendering engine 223 combines lerping with TAA in the blur textures, the rendering engine 223 can introduce a degree of temporal smoothing. While the primary purpose of this blur and motion is positional smoothing and capturing positional motion, the integration of TAA also addresses temporal differences. By incorporating TAA, the rendering engine 223 can mitigate concerns related to overshooting and extrapolation. For instance, without TAA, extrapolation could lead to negative values and peak values surpassing the previous peak, causing unintentional brightness increases. However, the utilization of TAA by the rendering engine 223 can reduce the occurrence of such overshooting, thereby enhancing the reliability of extrapolation capabilities in the overall blur and motion process.

Insufficient sigma values lead to motion artifacts, such as shutter effects, in which the presence of two visible peaks results in a double image phenomenon and contributes to judder. When sigma values are too low, they may not provide an adequate level of blurring to account for the motion and changes occurring between frames. As a result, the images may not smoothly transition, and the visual effects mentioned earlier, such as double images and judder, become more pronounced and perceptible to the viewer. For example, at 22.5 Hz, when rotating at approximately 90 degrees per second while holding an object behind a blurred texture, perceptible judder emerges. Thus, reducing the frame rate below 22.5 Hz would introduce judder in slower movements unless compensated by increasing sigma to maintain image quality. In contrast, increasing the sigma value appropriately helps to mitigate these effects by introducing a higher level of blurring that can smooth out the transition between frames and maintain visual quality, particularly at lower frame rates.

While the rendering engine 223 currently uses Gaussian distributions, there may be other kernels that offer comparable performance in approximating motion across various standard deviations. For example, the L infinity norm is a potential candidate for measuring the proximity of the interpolated peak to the translated peak, which holds perceptual significance. In one or more implementations, an optimal kernel can either be Gaussian or subtly different in a manner that does not significantly impact the final visual result or quality of the rendered images, possibly resulting in an approximate 10% improvement. The rendering engine 223 also can utilize alternative kernels to enhance motion approximation while ensuring the best possible visual quality.

FIG. 4 illustrates a flow diagram of an example process 400 for providing linear interpolation of reprojected blurred content in accordance with implementations of the subject technology. For explanatory purposes, the process 400 is primarily described herein with reference to the electronic device 105 of FIG. 1. However, the process 400 is not limited to the electronic device 105 of FIG. 1, and one or more blocks (or operations) of the process 400 may be performed by one or more other components of other suitable devices, including the electronic device 104, the electronic device 110, and/or the electronic device 115. Further for explanatory purposes, some of the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

As illustrated in FIG. 4, at block 410, the rendering engine 223 may reproject a first frame that includes a first blurred texture into a first reprojected frame using a first transformation associated with a viewing perspective of a user. In one or more implementations, the rendering engine 223 may generate the first blurred texture by applying a first convolution filter to the first frame based on a first kernel, such as a Gaussian distribution. The rendering engine 223 employs a mathematical operation called a “convolution filter” to generate the initial blurred texture for the first frame. This process involves applying the convolution filter, which is a matrix of numerical coefficients, to each pixel of the image. The coefficients in the convolutional filter can dictate how neighboring pixel values contribute to the calculation of a new pixel value. Specifically, the first convolutional filter, represented by the first kernel, facilitates the desired blurring effect in the first frame. The application of this convolution filter results in a softening or smoothing of image features, contributing to the creation of the first blurred texture.

At block 420, the rendering engine 223 may reproject a second frame that includes a second blurred texture into a second reprojected frame using a second transformation associated with the viewing perspective of the user. In one or more implementations, the rendering engine 223 may generate the second blurred texture by applying a second convolution filter to the second frame based on a second kernel, such as a Gaussian distribution. Here, the second convolutional filter, represented by the second kernel, facilitates the desired blurring effect in the second frame. The application of this convolution filter results in a softening or smoothing of image features, contributing to the creation of the second blurred texture.

At block 430, the rendering engine 223 may determine a motion approximation between the first reprojected frame and the second reprojected frame. In one or more implementations, the rendering engine 223 may apply linear interpolation between the first reprojected frame and the second reprojected frame to determine the motion approximation. In applying the linear interpolation, the rendering engine 223 may interpolate between a first Gaussian distribution corresponding to the first reprojected frame and a second Gaussian distribution corresponding to the second reprojected frame. In one or more other implementations, the first Gaussian distribution and the second Gaussian distribution are each offset relative to a respective mean. In some aspects, the offset corresponds to an offset value in a range of 0 to 1*σ, in which σ represents a standard deviation of at least one of the first Gaussian distribution or the second Gaussian distribution. For example, the first Gaussian distribution may have a mean of zero and the second Gaussian distribution may have a mean of 0.5 sigma. In determining the motion approximation, the rendering engine 223 may determine a translated Gaussian distribution representing a result of the applied linear interpolation between the first Gaussian distribution and the second Gaussian distribution such that the translated Gaussian distribution indicates the motion approximation.

In one or more other implementations, the rendering engine 223 applies extrapolation between the first reprojected frame and the second reprojected frame to determine the motion approximation. In applying the extrapolation, the rendering engine 223 may extrapolate between a first Gaussian distribution corresponding to the first reprojected frame and a second Gaussian distribution corresponding to the second reprojected frame. In some aspects, the first Gaussian distribution is offset by a first offset value and the second Gaussian distribution is offset by a second offset value different from the first offset value. In one or more implementations, the first offset value and the second offset value correspond to offset values in a range of 0 to 0.5*σ.

At block 440, the rendering engine 223 may render an intermediate frame based at least in part on the motion approximation, the intermediate frame being rendered between the first reprojected frame and the second reprojected frame. In one or more implementations, one or more of the first frame or the second frame is rendered at a first frame rate and the intermediate frame is rendered at a second frame rate that corresponds to the first frame rate. This facilitates that the motion appears fluid and continuous to the viewer.

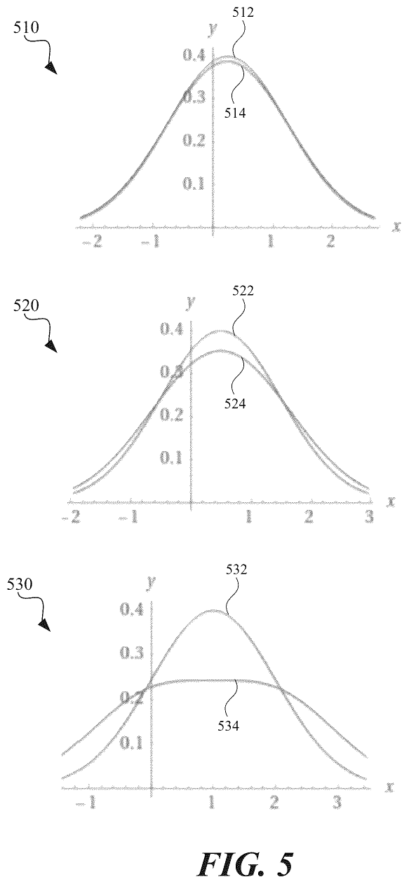

FIG. 5 illustrates graph diagrams providing different examples of linear interpolation of reprojected blurred content in accordance with one or more implementations of the subject technology. In the subject technology, the rendering engine 223 begins by reprojecting two frames of a sequence of frames being rendered using a transformation corresponding to a current viewing perspective of a user relative to prior viewing perspectives at the time those two frames were rendered, which involves transforming the content of the blurry textures to the current viewing perspective. This means that the rendering engine 223 transforms and aligns the blurred textures in such a way that rotational motion within the content is considered to accurately reflect the changes in the user's viewing perspective resulting from the rotation of their head and, consequently, track the orientation of the camera. The purpose of this reprojection is to align and position the images appropriately in the new frame. This step accurately accounts for any rotational changes in the content for the new frame. This step also ensures that the rendered content aligns correctly with the user's changing point of view, enhancing the immersive and realistic experience.

After the reprojection step, the rendering engine 223 then employs lerping to approximate the motion within the content. Lerping can be used to calculate the motion between the reprojected blurry textures. Pure lerping without reprojection is a viable option; however, it may be advantageous for the rendering engine 223 to utilize both techniques, i.e., reprojection and lerping together. For example, the rendering engine 223 proceeds with the lerping process between the reprojected blurry textures. The approximation of motion arises from the characteristics of two Gaussian distributions. As previously discussed, a Gaussian distribution is a mathematical function that represents a bell-shaped curve with a mean value. In some examples, the lerping may be performed between a Gaussian with a mean at zero and another Gaussian with a mean at 0.5.

When performing linear interpolation (lerping) at the midpoint between these two Gaussian distributions, the rendering engine 223 achieves a result that is nearly identical to the characteristics of both Gaussian distributions. This characteristic of the Gaussian distributions allows the rendering engine 223 to accurately capture the actual motion within the content during the lerping process. Overall, the rendering engine 223 combines reprojection and lerping techniques to accurately approximate the motion within the blurry content. By performing rotational reprojection and leveraging the properties of Gaussian distributions during lerping, the rendering engine 223 facilitates a high-quality and visually appealing result in the final frame.

In one or more implementations, a representation is used to define the axes in a two-dimensional space. The x-axis in this representation corresponds to the standard deviations, which are measured in terms of the sigma value previously discussed. Here, the sigma value represents the standard deviation of one, which serves as a reference point for measuring other standard deviations along the x-axis. On the other hand, the y-axis in this representation represents the height of the Gaussian probability distribution. The height of the Gaussian probability distribution is denoted as the PDF (Probability Density Function) height. The PDF height signifies the probability of a particular value occurring within the distribution. By using this two-dimensional representation with the x and y-axes defined accordingly, the rendering engine 223 can visually analyze the Gaussian curve and understand the characteristics of Gaussian probability distributions. This representation allows for a clear visualization of how standard deviations and probability densities are related in the context of Gaussian distributions.

As illustrated in graph 510, curve 514 represents the result of linear interpolation between two Gaussian probability distributions. Linear interpolation involves creating a smooth transition between two values or Gaussian distributions by taking a weighted average of them. In this regard, the lerping curve 514 shows how the Gaussian distributions change as the rendering engine 223 transitions between two frames. Curve 512, on the other hand, signifies the effect of translation applied to a Gaussian distribution. For example, the curve 512 refers to the Gaussian distribution that represents an older frame after it has been reprojected to match user's current perspective. In one or more implementations, the rendering engine 223 can consider the widening of curve 514, representing the newer frame, in comparison to curve 512, representing the older frame, during Gaussian interpolation. The width of the curve corresponds to the standard deviation, which directly influences the blurriness of the resulting image. A wider curve indicates a larger standard deviation, resulting in a blurrier image, though not necessarily noticeable to the human eye.

The rendering engine 223 can utilize lerping and translation techniques to achieve accurate motion approximation while maintaining visual coherence. The main objective of this operation is to align the lerping peak (e.g., curve 514) with the translated Gaussian peak (e.g., curve 512) to create a visually seamless and nearly identical appearance to the human eye. This alignment simulates the effect of recomputing an intermediate image, resulting in a smooth and natural transition between frames.

The successful alignment of the lerping peak with the translated Gaussian peak can facilitate a high-quality and natural appearance, minimizing judder and providing a smooth experience for viewers. In this regard, the rendering engine 223 can monitor the lerping and translation processes to prevent significant separation between the Gaussians to avoid visual degradation and double image effects that can lead to perceived judder.

However, the effectiveness of this approach starts to degrade when the two Gaussian curves are significantly far apart from each other. For example, as illustrated in graph 520, curve 524, representing the lerping process, is not aligned with curve 522, representing the translation of the Gaussian distribution. In this case, the lerping peak of curve 524 fails to align with the translated Gaussian peak of curve 522, leading to visual discrepancies and noticeable differences to the human eye. This alignment facilitates direct influence on the perception of blurry object edges by the human visual system.

As the difference between the two Gaussian curves increases, specifically when it reaches two standard deviations, a notable double image effect occurs. For example, as illustrated in graph 530, curve 534, representing the lerping process, is substantially misaligned from curve 532, representing the translation of the Gaussian distribution. In this case, the lerping peak of curve 534 does not align with the translated Gaussian peak of curve 532, leading to this double image phenomenon that creates a perception of judder, which is commonly associated with reduced framerates. The performance of the lerping operation decreases when the motion exceeds two standard deviations. However, when the motion stays within two standard deviations, the lerping operation performs effectively, and there is no noticeable judder. In one or more implementations, the motion approximation may be determined based on a difference between the translated Gaussian distribution and the lerping Gaussian distribution being within two standard deviations. In such cases, the lerping and translation processes combine harmoniously to provide a smooth and visually pleasing outcome to the human eye.

To facilitate a constant standard deviation and maintain consistent blurriness during the lerping operation, the rendering engine 223 can store progressively blurrier versions of both the newest and older frames. By having precomputed blurrier versions of these frames, the rendering engine 223 can achieve a consistent blur level throughout the interpolation process, leading to a more visually stable and seamless result. In scenarios where generating the original image and subsequently blurring it incurs significantly higher computational costs, this approach becomes more viable. In such cases, having precomputed blurrier versions of frames can result in a more consistent experience with a constant sigma value and perceived stability.

Exemplary embodiments have depicted a simplified one-dimensional scenario illustrated by depicting the lerped image, which is a linear interpolation between half of frame zero and half of frame two of a sequence of four frames over which lerping is being applied. However, the subject technology can incorporate additional images, such as the blurry images at frame zero, frame one, and frame two, to provide a more comprehensive comparison. By including supplementary images, the subject technology can enhance clarity and understanding of the lerping process and its effects on the resulting images. The understanding of the lerping process is enhanced through a more comprehensive analysis and visualization of its effects on image transitions and quality. These additional images can help visualize how the lerping operation smoothly transitions between frames and captures the motion between frames and blurriness present in each frame through enhanced clarity and context. The analysis of multiple frames allows for a more detailed examination of the temporal changes and motion within the images. It enables the subject technology to study the transition from one frame to another, considering both the position and blurriness, which are factors in achieving a visually smooth and coherent result. By expanding the analysis to include more frames and supplementary images, the operation gains a deeper insight into the effectiveness of the lerping process and its impact on the final images.

FIG. 6 illustrates graph diagrams providing different examples of extrapolation of reprojected blurred content to predict future values beyond the existing data points in accordance with one or more implementations of the subject technology. By extrapolating and then displaying predicted blur content while waiting for that blur content to be rendered, perceived latency for the user may be reduced.

If desired, the interpolation scheme can be extended beyond images that have already been rendered, to predict future blurred content. In other words, such extrapolation allows the rendering engine 223 to predict and estimate the content of frames at positions where they have not been directly computed. In one or more implementations, the positions may refer to specific points or instances in time along the sequence of frames. Each position may correspond to a particular moment at which content of a frame is computed. For example, in a video sequence, positions could represent successive time intervals. By extending the interpolation scheme to predict future content and displaying the predicted future content, perceived latency of the interpolation scheme may be reduced.

The rendering engine 223 has the flexibility to employ higher values for the linear progression, which can extend beyond 1.0 if desired. This extension involves the optional use of an extrapolation technique, in which the rendering engine 223 seeks to predict values beyond the known data points. While extrapolation is available as an option, the rendering engine 223 may, in one or more implementations, forego performing extrapolation. Instead, the rendering engine 223 may be configured to operate within the range of values from zero to one for the linear progression. As illustrated in FIG. 6, the graph 610 includes curve 614, representing the optional extrapolation operation, which closely aligns with curve 612, representing the translated Gaussian distribution, both having mean values with the zero to one sigma range.

In one or more implementations, the rendering engine 223 can extend the Gaussian curve beyond its current boundaries (e.g., as seen in curves 612 and 614 of graph 610) to achieve some degree of extrapolation. This extension allows for some degree of extrapolation, predicting values beyond the existing data range. For example, extrapolation may be utilized to project forward by half a frame, accommodating for variable amounts of translation. In one or more implementations, the rendering engine 223 may selectively perform extrapolation based on characteristics of the blurred content. For example, the rendering engine 223 may employ extrapolation to offset a gaussian blur when that offset is less than 0.5 sigma; but, employ a different reprojection technique when the offset is greater than 0.5 sigma of the gaussian blur. In other words, the rendering engine 223 may selectively employ linear extrapolation when the predicted difference from already-rendered blur content is relatively small. In one or more implementations, the rendering engine 223 determines a motion approximation by way of extrapolation, even when projecting forward by half a sigma (e.g., as seen in curves 622 and 624 of graph 620). In one or more other implementations, the rendering engine 223 may determine the motion approximation by way of extrapolation when projecting forward by a full sigma (e.g., as seen in curves 632 and 634 of graph 630).

In one or more implementations, extrapolation is used to facilitate a more seamless and responsive user experience. By reducing the latency associated with the blurring process through extrapolation, the operation aims to provide users with a visually smooth and consistent experience. This approach helps maintain the integrity of the real-time rendering process, even at reduced frame rates or when dealing with blurring effects, enhancing the overall performance and usability of the system. For example, lowering latency facilitates a responsive and seamless user experience, especially in real-time applications where delays can negatively impact interactivity and user satisfaction. To address latency concerns, the operation considers various other approaches that may be included in the steps of the process.

While extrapolation serves as a means to achieve reduced latency, in one or more implementations, it may not be the first step taken in the latency reduction process. For example, the rendering engine 223 may first (or later) attempt one or more other techniques and/or strategies to mitigate latency and improve system performance. These approaches may include optimizing rendering algorithms, reducing computation overhead, and enhancing data processing efficiency.

The incorporation of extrapolation introduces a technique to address latency concerns that may have been unaddressed in traditional techniques. By utilizing extrapolation as part of the workflow, the rendering engine 223 enhances its ability to reduce latency. Extrapolation allows the system to make informed predictions about the content of intermediate frames, thereby reducing the need for complete frame computations and shortening the time required for rendering. The integration of extrapolation into the workflow ultimately enhances the overall user experience. By minimizing latency through this technique, the rendering engine 223 facilitates smoother motion, improved responsiveness, and a more immersive viewing experience for users.

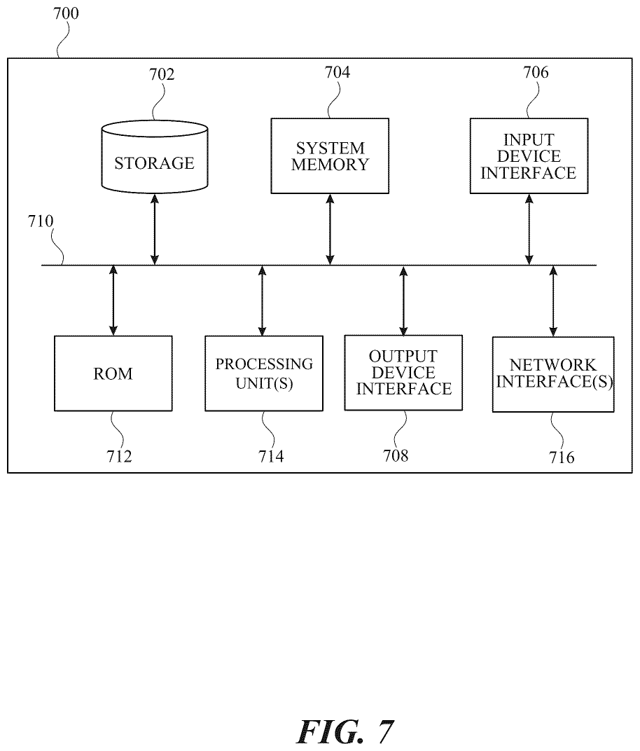

FIG. 7 illustrates an example computing device with which aspects of the subject technology may be implemented in accordance with one or more implementations. The computing device 700 can be, and/or can be a part of, any computing device or server for generating the features and processes described above, including but not limited to a laptop computer, a smartphone, a tablet device, a wearable device such as a goggles or glasses, and the like. The computing device 700 may include various types of computer readable media and interfaces for various other types of computer readable media. The computing device 700 includes a permanent storage device 702, a system memory 704 (and/or buffer), an input device interface 706, an output device interface 708, a bus 710, a ROM 712, one or more processing unit(s) 714, one or more network interface(s) 716, and/or subsets and variations thereof.

The bus 710 collectively represents all system, peripheral, and chipset buses that communicatively connect the numerous internal devices of the computing device 700. In one or more implementations, the bus 710 communicatively connects the one or more processing unit(s) 714 with the ROM 712, the system memory 704, and the permanent storage device 702. From these various memory units, the one or more processing unit(s) 714 retrieves instructions to execute and data to process in order to execute the processes of the subject disclosure. The one or more processing unit(s) 714 can be a single processor or a multi-core processor in different implementations.

The ROM 712 stores static data and instructions that are needed by the one or more processing unit(s) 714 and other modules of the computing device 700. The permanent storage device 702, on the other hand, may be a read-and-write memory device. The permanent storage device 702 may be a non-volatile memory unit that stores instructions and data even when the computing device 700 is off. In one or more implementations, a mass-storage device (such as a magnetic or optical disk and its corresponding disk drive) may be used as the permanent storage device 702.

In one or more implementations, a removable storage device (such as a flash drive and its corresponding solid-state drive) may be used as the permanent storage device 702. Like the permanent storage device 702, the system memory 704 may be a read-and-write memory device. However, unlike the permanent storage device 702, the system memory 704 may be a volatile read-and-write memory, such as random access memory. The system memory 704 may store any of the instructions and data that one or more processing unit(s) 714 may need at runtime. In one or more implementations, the processes of the subject disclosure are stored in the system memory 704, the permanent storage device 702, and/or the ROM 712. From these various memory units, the one or more processing unit(s) 714 retrieves instructions to execute and data to process in order to execute the processes of one or more implementations.

The bus 710 also connects to the input and output device interfaces 706 and 708. The input device interface 706 enables a user to communicate information and select commands to the computing device 700. Input devices that may be used with the input device interface 706 may include, for example, alphanumeric keyboards and pointing devices (also called “cursor control devices”). The output device interface 708 may enable, for example, the display of images generated by computing device 700. Output devices that may be used with the output device interface 708 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 7, the bus 710 also couples the computing device 700 to one or more networks and/or to one or more network nodes through the one or more network interface(s) 716. In this manner, the computing device 700 can be a part of a network of computers (such as a LAN, a wide area network (“WAN”), or an Intranet, or a network of networks, such as the Internet. Any or all components of the computing device 700 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components (e.g., computer program products) and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
reprojecting a first frame comprising a first blurred texture into a first reprojected frame using a first transformation associated with a viewing perspective of a user;
reprojecting a second frame comprising a second blurred texture into a second reprojected frame using a second transformation associated with the viewing perspective of the user;
determining a motion approximation between the first reprojected frame and the second reprojected frame; and
rendering an intermediate frame based at least in part on the motion approximation, the intermediate frame being rendered between the first reprojected frame and the second reprojected frame.

2. The method of claim 1, further comprising:
generating the first blurred texture by applying a first convolution filter to the first frame based on a first kernel; and
generating the second blurred texture by applying a second convolution filter to the second frame based on a second kernel.

3. The method of claim 1, wherein the determining the motion approximation comprises applying linear interpolation between the first reprojected frame and the second reprojected frame.

4. The method of claim 3, wherein the applying the linear interpolation comprises interpolating between a first Gaussian distribution corresponding to the first reprojected frame and a second Gaussian distribution corresponding to the second reprojected frame.

5. The method of claim 4, wherein the first Gaussian distribution and the second Gaussian distribution are each located at a mean that corresponds to an offset value.

6. The method of claim 5, wherein the offset value is in a range of 0 to 1*σ, where σ represents a standard deviation of at least one of the first Gaussian distribution or the second Gaussian distribution.

7. The method of claim 4, wherein the determining the motion approximation comprises determining a translated Gaussian distribution representing a result of the applied linear interpolation between the first Gaussian distribution and the second Gaussian distribution, the translated Gaussian distribution indicating the motion approximation.

8. The method of claim 1, wherein the determining the motion approximation comprises applying extrapolation between the first reprojected frame and the second reprojected frame.

9. The method of claim 8, wherein the applying the extrapolation comprises extrapolating between a first Gaussian distribution corresponding to the first reprojected frame and a second Gaussian distribution corresponding to the second reprojected frame, wherein the first Gaussian distribution is offset by a first offset value and the second Gaussian distribution is offset by a second offset value different from the first offset value.

10. The method of claim 9, wherein the first offset value and the second offset value correspond to offset values in a range of 0 to 0.5*σ, where σ represents a standard deviation of at least one of the first Gaussian distribution or the second Gaussian distribution.

11. The method of claim 1, wherein one or more of the first frame or the second frame is rendered at a first frame rate and the intermediate frame is rendered at a second frame rate corresponding to the first frame rate.

12. A device, comprising:
a memory; and
one or more processors configured to:
reproject a plurality of previous frames having blurred textures into respective ones of a plurality of reprojected blurred frames using one or more transformations associated with a viewing perspective of a user;
determine a motion approximation between the plurality of reprojected blurred frames by applying interpolation between a plurality of kernel distributions associated with respective ones of the plurality of reprojected blurred frames; and
render an intermediate frame based at least in part on the motion approximation, the intermediate frame being rendered between two reprojected blurred frames of the plurality of reprojected blurred frames.

13. The device of claim 12, further comprising:
generating a first blurred texture in a first frame of the plurality of previous frames by applying a first convolution filter to the first frame based on a first kernel; and
generating a second blurred texture in a second frame of the plurality of previous frames by applying a second convolution filter to the second frame based on a second kernel.

14. The device of claim 12, wherein the determining the motion approximation comprises applying linear interpolation between a first reprojected blurred frame of the plurality of reprojected blurred frames and a second reprojected blurred frame of the plurality of reprojected blurred frames, wherein the applying the linear interpolation comprises interpolating between a first Gaussian distribution corresponding to the first reprojected blurred frame and a second Gaussian distribution corresponding to the second reprojected blurred frame.

15. The device of claim 14, wherein the first Gaussian distribution and the second Gaussian distribution are each located at a mean that corresponds to an offset value, wherein the offset value is in a range of 0 to 1*σ, where σ represents a standard deviation of at least one of the first Gaussian distribution or the second Gaussian distribution.

16. The device of claim 14, wherein the determining the motion approximation comprises determining a translated Gaussian distribution representing a result of the applied linear interpolation between the first Gaussian distribution and the second Gaussian distribution, the translated Gaussian distribution indicating the motion approximation.

17. The device of claim 12, wherein the determining the motion approximation comprises applying extrapolation between a first reprojected blurred frame of the plurality of reprojected blurred frames and a second reprojected frame of the plurality of reprojected blurred frames, wherein the applying the extrapolation comprises extrapolating between a first Gaussian distribution corresponding to the first reprojected blurred frame and a second Gaussian distribution corresponding to the second reprojected blurred frame, wherein the first Gaussian distribution is offset by a first offset value and the second Gaussian distribution is offset by a second offset value different from the first offset value.

18. The device of claim 17, wherein the first offset value and the second offset value correspond to offset values in a range of 0 to 0.5*σ, where σ represents a standard deviation of at least one of the first Gaussian distribution or the second Gaussian distribution.

19. The device of claim 12, wherein the motion approximation is determined based on a difference between at least two of the plurality of kernel distributions being within two standard deviations.

20. A non-transitory computer-readable medium storing instructions that, when executed by one or more processors, cause the one or more processors to perform operations comprising:
reprojecting a first frame comprising a first blurred texture into a first reprojected frame using a first transformation associated with a viewing perspective of a user;
reprojecting a second frame comprising a second blurred texture into a second reprojected frame using a second transformation associated with the viewing perspective of the user;
determining a motion approximation between the first reprojected frame and the second reprojected frame; and
rendering an intermediate frame based at least in part on the motion approximation, the intermediate frame being rendered between the first reprojected frame and the second reprojected frame.
